(19) United States
(12) Patent Application Publication
(10) Pub. No.: US 2011/0128656 A1
(43) Pub. Date: Jun. 2, 2011

(54) OUTPUT SHORT CIRCUIT PROTECTION FOR ELECTRONIC TRANSFORMERS

(75) Inventor: Raymond Kohler, Souderton, PA (US)

(73) Assignee: MDL Corporation, Philadelphia, PA (US)

(21) Appl. No.: 11/962,705

(22) Filed: Dec. 21, 2007

Related U.S. Application Data
(60) Provisional application No. 60/871,637, filed on Dec. 22, 2006.

(51) Int. Cl. H02H 7/04

(52) U.S. Cl. 361/35

(57) ABSTRACT

An overcurrent protection control circuit for an electronic transformer includes a feedback current detection circuit, an averaging circuit and an overcurrent shutdown circuit. The feedback current detection circuit detects feedback current of an output of the electronic transformer. The averaging circuit determines an average of the feedback current detected by the feedback current detection circuit. The overcurrent shutdown circuit is configured to shutdown the output of the electronic transformer based on the average of the feedback current exceeding a predetermined threshold. The predetermined threshold indicates a short circuit condition.

### CROSS-REFERENCE TO RELATED APPLICATIONS

This application claims priority to U.S. Provisional Patent Application No. 60/871,637, filed Dec. 22, 2006, entitled “Output Short Circuit Protection for Electronic Transformers.”

### BACKGROUND OF THE INVENTION

Embodiments of the present invention generally relate to control circuits for electronic transformers, and more particularly, to an output short circuit detection and protection control circuit for electronic transformers.

Electronic transformers typically convert 60 Hertz (Hz) power line frequency to a higher frequency, typically about 20 to 30 kiloHertz (kHz). This has benefits of lower cost, smaller size, lighter weight, and higher efficiency. Electronic transformers are typically used for powering low voltage lighting on systems with bare or exposed conductors.

It is desirable to improve short circuit and overload protection of electronic transformers for two common applications. The first application is where the electronic transformer is installed on a relatively long exposed bus (e.g., greater than about 10 feet). Because the bus is exposed, the chance of a short circuit is generally high. A problem can occur when a short circuit occurs on the bus at or near the end opposite to the electronic transformer. The small inductance of the bus creates a significant impedance to the electronic transformer's high frequency and limits the current to a level that cannot be detected. Because the conventional electronic transformer cannot detect such a distant short circuit condition, it does not shut down. The result is that the short circuit may overheat causing an unsafe situation or failure of the electronic transformer. Secondly, traditional electronic transformers cannot detect if additional lamps are added with the bus powered.

Traditional output short circuit protection for electronic transformers includes a fast acting overcurrent detection circuit that shuts down oscillations in the transformer in order to prevent failure or hazardous high currents from starting a fire. The traditional shutdown methods typically compare a peak current of the electronic transformer to a normal peak start-up current of cold filament lamps driven by the electronic transformer. When the output is shorted, the current exceeds the normal peak start-up current of the cold filament lamps and the electronic transformer output is shut down. However, when a short occurs at the end of a relatively long bus with additional cable inductance, the resulting current does not exceed the peak startup current and no shutdown occurs. This occurs because the small inductance of the bus creates significant impedance to the electronic transformer's high frequency so that the shorted output current is the same or substantially the same amplitude as the cold lamp start up current.

It is desirable to provide an output short circuit detection and protection control circuit for electronic transformers. Further, it is desirable to provide an overcurrent protection control circuit for an electronic transformer.

### BRIEF SUMMARY OF THE INVENTION

Briefly stated, an embodiment of the present invention comprises an overcurrent protection control circuit for an electronic transformer. The overcurrent protection control circuit includes a feedback current detection circuit, an averaging circuit and an overcurrent shutdown circuit. The feedback current detection circuit detects feedback current of an output of the electronic transformer. The averaging circuit determines an average of the feedback current detected by the feedback current detection circuit. The overcurrent shutdown circuit is configured to shutdown the output of the electronic transformer based on the average of the feedback current exceeding a predetermined threshold. The predetermined threshold indicates a short circuit condition.

### BRIEF DESCRIPTION OF THE VIEW OF THE DRAWING

The foregoing summary, as well as the following detailed description of preferred embodiments of the invention, will be better understood when read in conjunction with the appended drawing. For the purpose of illustrating various embodiments of the invention, there is shown in the drawing an embodiment which is presently preferred. It should be understood, however, that the invention is not limited to the precise arrangements and instrumentalities shown.

In the drawing:

FIG. 1 is an electrical schematic diagram of an overcurrent protection control circuit for an electronic transformer in accordance with a preferred embodiment of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer direction toward and away from, respectively, the geometric center of the object described and designated parts thereof. The terminology includes the words above specifically mentioned, derivatives thereof and words of similar import. Additionally, the words “a” and “an,” as used in the claims and in the corresponding portion of the specification, mean “at least one.” Moreover, the term “overcurrent protection” can also refer to “overload protection” and/or “short circuit protection.”

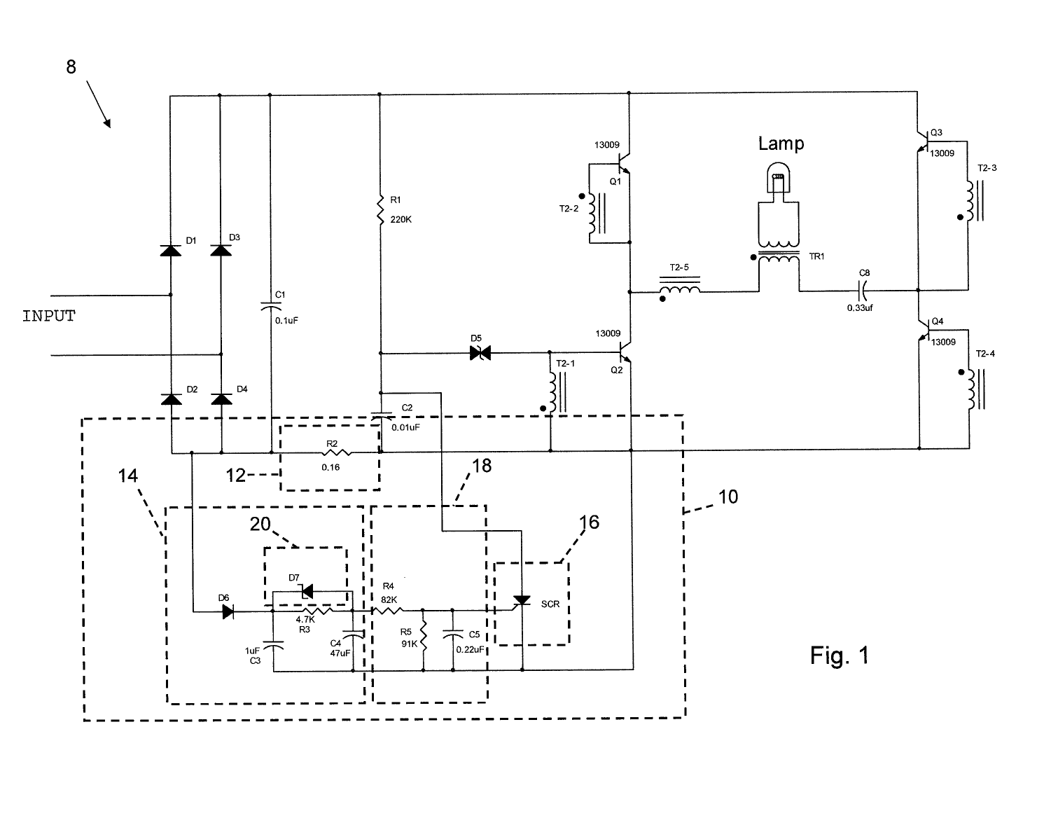

Referring to the drawing in detail, wherein like numerals reference like elements throughout, there is shown in FIG. 1 an overcurrent protection control circuit 10 for an electronic transformer 8 in accordance with the preferred embodiment of the present invention. In this exemplary embodiment, the electronic transformer 8 includes five windings T2-1 through T2-5, but may include more windings T2-n (not shown) for additional sensing and/or feedback. The overcurrent protection control circuit 10 includes a feedback current detection circuit 12, an averaging circuit 14, a low pass filter 18, a quasi-peak detector 20 and an overcurrent shutdown circuit 16. Current flows through primary winding T2-5 to transformer TR1 which provides power to one or more lamps on a bus. The feedback current detection circuit 12 detects feedback current of an output of the electronic transformer 10. The feedback current detection circuit 12 may be a resistor R2 or may include additional or different current detection components. The averaging circuit 14 determines an average of the feedback current detected by the feedback current detection circuit 12. The averaging circuit 14 may include a diode D6, a resistor R3, capacitors C3-C4 and a quasi-peak detector 20 such as Zener diode D7. The low pass filter 18 includes resistors R4 and R5 and capacitor C5. The overcurrent shutdown circuit 16 is configured to shutdown the output of the electronic transformer 10 based on the average of the feedback current determined by the averaging circuit 14. The shutdown circuit 16 preferably includes a silicon controlled rectifier SCR or the like.

While depicted in FIG. 1 as analog circuitry, some or all of the overcurrent protection control circuit 10 can be implemented as integrated circuits (ICs), microcontrollers, microprocessors, application specific integrated circuits (ASICs), programmable logic arrays (PLAs) or the like without departing from the present invention. For example, using an analog to digital (A/D) converter, a controller may receive sensed current and provide the averaging of the feedback current and detection of the average current exceeding a predetermined limit.

High inductance short circuits can be reliably detected if the overcurrent protection control circuit 10 is provided in order to compare the average feedback current to the normal average feedback current. It is desirable to provide a long time constant low pass filter 18 to insure that the normal cold lamp peak startup current is filtered out. Since the increased current caused by a high inductance short circuit persists, it is passed through the long time constant filter 18 to the SCR which fires, tripping the shutdown of the output of the electronic transformer 8 by turning off transistor Q2. Fast shutdown is still desirable to quickly protect components of the electronic transformer 8 from the generally high currents that occur with a low impedance shorts, close to the output of the electronic transformer 8.

A fast peak or quasi-peak detector 20 is also used to provide a relatively fast response. The quasi-peak detector 20 is provided with filtered signal with a time constant longer than the warm-up time for the lamps. This removes the possibility of the high lamp start surge current from triggering shut down. When a short circuit occurs close the electronic transformer 8, the current is much higher because there is less impedance in the output circuit to limit the current. For this case, the time constant is shortened shutting down the transformer 8 quickly to avoid damage. Use of the average of the peak current has many advantages over the simple average.

As the output current increases, stray inductance in the circuitry of the electronic transformer 8 stores extra energy. The stored energy is released by the high frequency switching action of the electronic transformer 8 and shows up as glitches or spikes in the output current. When normal loads are present the spikes are not significant and the output load resistance helps dampen them out. When the load increases, the amplitude of the spikes increase more then the average current. When the output is shorted, there is no resistance to dampen the spikes. The under-damped stray inductance resonates and causes the spikes to get even bigger because an undamped resonance causes current gain. A simple average detector filters out the spikes and only responds to the average or base current. When the quasi-peak detector 20 precedes the averaging filter 14, the amplitude of the spike is also detected and increases the sensitivity of the quasi-peak detector 20 to differentiate between normal load current and limited shorting faults. When a short is applied at the end of a long bus, the inductance does two things, it limits the current and stores energy without any dissipation. The quasi-peak detector 20 has a higher output voltage so the current sense resistor R2 can be a lower value and less power is dissipated thereby increasing system efficiency.

FIG. 1 shows a self-oscillating full bridge topology electronic transformer 8. Feedback is provided by transformer winding T2-1, which is a small saturating transformer. Resistor R1 charges capacitor C2 until a diac D5 is triggered. Transistor Q2 is turned on starting full bridge oscillations. Resistor R2 is a current sense resistor that monitors return current from transistors Q2 and Q4. The voltage across resistor R2 charges capacitor C3 through diode D6. A low voltage Schottky diode D6 is used to increase the sensitivity of the overcurrent protection control circuit 10. Resistors R4 and R5 and capacitor C5 form the low pass filter 18. Preferably, the low pass filter 18 has a long, approximately 220 millisecond (ms) time constant which filters out the normal cold lamp peak startup current. During startup, the lamp resistance is five to ten times less than its resistance during continuous use. This causes a very high surge current with an exponential decay back to the steady state value. The long time constant of the filter 18 cancels out the surge and the voltage on capacitor C4 rises to the steady state value with very little overshoot. This is important because the shutdown threshold is set very close to the steady state current. Since the increased current caused by the high inductance short persists, it is passed through the long time constant filter 18 tripping the shutdown of the electronic transformer 8 by triggering the SCR to turn off transistor Q2. Resistors R4 and R5 are a voltage divider that set the trigger threshold of the SCR. When the SCR is triggered, capacitor C2 is discharged preventing restart of the bridge oscillations after the power line zero crossings.

Another means of disabling the bridge oscillations is to connect the anode of the SCR to transformer winding T2-1. This stops the oscillations immediately instead of waiting until the zero crossing. The zener voltage of zener diode D7 is set to a value so the voltage across resistor R3 during normal peak start-up current of cold filament lamps is less than the zener voltage. When a short is placed close to the electronic transformer 8, the output current is much higher than the normal peak start-up current of cold filament lamps. Such a higher voltage causes the zener diode D7 to conduct charging capacitor C4 quickly and shutting down the electronic transformer 8 more rapidly.

Alternately, instead of an SCR, the overcurrent shutdown circuit 16 may include a flip-flop circuit, a multi-transistor latch, a relay, or any other electrical/electronic switching device.

While FIG. 1 shows that the overcurrent protection control circuit 10 includes a manual reset (i.e., requiring the entire electronic transformer 8 to be power-cycled), it is contemplated that the overcurrent protection control circuit 10 includes either or both of a manual reset and an autoreset.

Moreover, while FIG. 1 shows that the overcurrent protection control circuit 10 is applied in an alternating current (AC) application, it is contemplated that variations of the overcurrent protection control circuit 10 can be applied in a direct current (DC) application as well.

From the foregoing, it can be seen that embodiments the present invention comprises control circuits for electronic transformers, and more particularly, to an output short circuit detection and protection control circuit for electronic transformers. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An overcurrent protection control circuit for an electronic transformer comprising:
a feedback current detection circuit that detects feedback current of an output of the electronic transformer;
an averaging circuit that determines an average of the feedback current detected by the feedback current detection circuit; and
an overcurrent shutdown circuit configured to shutdown the output of the electronic transformer based on the average of the feedback current exceeding a predetermined threshold, the predetermined threshold indicating a short circuit condition.

2. The overcurrent protection control circuit according to claim 1, wherein the overcurrent shutdown circuit has a trip-point that is greater than the approximate steady state value of the feedback current.

3. The overcurrent protection control circuit according to claim 1, wherein the overcurrent shutdown circuit does not respond to transients below a peak threshold.

4. The overcurrent protection control circuit according to claim 1, wherein the overcurrent protection control circuit has a fast response above a peak threshold.

5. The overcurrent protection control circuit according to claim 1, wherein the averaging circuit includes a quasi-peak detector followed by an averaging filter.

6. The overcurrent protection control circuit according to claim 1, further comprising one of a manual reset and an autoreset.
